(19) United States
(12) Patent Application Publication
(10) Pub. No.: US 2014/0362685 A1
(43) Pub. Date: Dec. 11, 2014

(54) METHOD AND APPARATUS FOR DYNAMIC CHANNEL MANAGEMENT IN RADIO SYSTEM SUPPORTING MULTIPLE CHANNELS

(71) Applicant: Electronics and Telecommunications Research Institute, Daejeon (KR)

(72) Inventor: Chang-Joo KIM, Daejeon (KR)

(73) Assignee: Electronics and Telecommunications Research Institute, Daejeon (KR)

(21) Appl. No.: 13/952,103

(22) Filed: Jul. 26, 2013

(30) Foreign Application Priority Data
Jun. 5, 2013 (KR) 10-2013-0064738

(51) Int. Cl. H04L 12/707; H04W 24/04

(52) U.S. Cl. CPC H04L 45/22; H04W 24/04
USPC 370/227

(57) ABSTRACT

A method for dynamically managing channels in a DSA radio system that supports multiple channels, includes producing a number of rendezvous combinations by pairing operating channels and backup channels in an 1:1 relation based on an available channel list. Further, the method includes when an arbitrary operating channel in a rendezvous combination is not suitable for communications, extracting a backup channel from the rendezvous combination to which the arbitrary operating channel belongs; and switching the extracted backup channel as an operating channel to continue a communication.

### CROSS-REFERENCE TO RELATED APPLICATION(S)

The present invention claims priority of Korean Patent Application No. 10-2013-0064738, filed on Jun. 5, 2013, which is incorporated herein by reference.

### FIELD OF THE INVENTION

The present invention relates to a channel management in a radio system; and more particularly, to a method and apparatus for managing channels in a DSA (Dynamic Spectrum Access) radio system that supports multiple channels.

### BACKGROUND OF THE INVENTION

Recently, with the rapid development of radio communications, various types of radio communication systems have been widely spread and consequent demand for spectrum that is the most important element in the radio communications has been exponentially increasing. In order to co-exist various types of the radio communication systems without interfering with each other, different frequency bands have been assigned to the different radio communication systems so far. However, since limited frequency resources cannot meet a frequency demand rapidly increasing around mobile communications, it is needed to increase a spectral efficiency through a spectrum sharing to dynamically use the frequency resources. Therefore, in the IEEE 802.22 standards group, the WRAN (Radio Regional Area Network) standard has been established to provide broadband radio services in rural areas by making use of channels that are not used regionally among channels of TV broadcasts. Further, the DARPA in the United States has been developing a DSA (Dynamic Spectrum Access) technology to communicate using the frequency of 960 MHz˜6 GHz band through a project WNaN (Radio Network after Next).

A communication system using the DSA technology may manage channels in a variety of classes, that is, it may classify the channels into an operating channel, a backup channel, a candidate channel, an unclassified channel and a protected channel for the spectrum management thereof. In such a communication system, there may occur a situation where a specific operating channel is no longer available due to the appearance of a primary user or the generation of a jamming when a communication is performed through the specific operating channel. In this case, it is necessary to select the same backup channel between two communicating parties to make a rendezvous in the same channel in a short time.

In other words, in the DSA communication system using multiple channels, when such appearance of the primary user or generation of a jamming causes the channel to be switched, DSA technologies to switch quickly and accurately the channel for a seamless communication are required. One of such technologies provides a method that arranges a set of backup channels and selects one or more channels of the set depending on a priority to switch as an operating channel. However, this method cannot guarantee an exact rendezvous. That is, in a case where one communicating party has changed the channel by sensing the appearance of the primary user or the jamming, while the other communicating party cannot sense it, or in a case where two or more channels are changed, a list of backup channels in an ad-hoc radio communication system may be different, which makes a channel management unstable.

Accordingly, there is a need for a technology which allows a multi-channel radio system to perform a stable and simple channel switching by providing a plan which manages prescribed channels to back up an operating channel for each communication channel in advance and immediately updates the backup channels after a channel switching has been made.

### SUMMARY OF THE INVENTION

In view of the above, the present invention provides a method and apparatus for dynamically managing radio channels in a DSA radio communication system that supports multiple channels, capable of switching an operating channel to backup channel rapidly and correctly when they need to switch the channel due to the appearance of a primary user or the generation of a jamming.

In accordance with a first aspect of the present invention, there is provided a method for dynamically managing radio channels in a DSA radio system that supports multiple channels. The method includes producing a number of rendezvous combinations by pairing operating channels and backup channels in an 1:1 relation based on an available channel list; when an arbitrary operating channel in a rendezvous combination is not suitable for communication, extracting a backup channel from the rendezvous combination to which the arbitrary operating channel belongs; and assigning the extracted backup channel as an operating channel to continue a seamless communication.

Further, the available channel list may be composed of an operating channel set, a backup channel set, a candidate channel set, and unclassified channel set.

Further, the method may further comprise after assigning the extracted backup channel to the operating channel, assigning a candidate channel from the candidate channel set to the backup channel; and producing a new rendezvous combination using the updated operating channel and the updated backup channel.

Further, extracting one channel in the candidate channel set may comprise extracting a candidate channel to meet the requirements of the corresponding RF channel, in which the extracted candidate channel has similar characteristics as the backup channel extracted as a new operating channel.

Further, the method may further comprise after switching the extracted backup channel as an operating channel, updating the candidate channel set by changing the priority of the respective channels in the candidate channel set.

Further, the method may further comprise putting the channel, which was eliminated from the operating channel, in the unclassified channel set to check the possible use some time later and performing a channel sensing on the channels in the updated unclassified channel set and updating the candidate channel set on the basis of the channel sensing.

In accordance with a second aspect of the present invention, there is provided an apparatus for dynamically managing radio channels in a DSA radio system that supports multiple channels. The apparatus includes a channel management unit configured to pair operating channels and backup channels in an 1:1 relation to produce a number of rendezvous combinations based on an channel list assigned to the radio system; and a channel switching unit configured to, when any arbitrary operating channel is not suitable any more for communication in a rendezvous combination, extract a backup channel from the rendezvous combination to which any operating channel belongs and assign the extracted backup channel to an operating channel.

Further, the channel management unit may be configured to classify the channels in available channel list into an operating channel set, a backup channel set, a candidate channel set, and unclassified channel set for the management thereof.

Further, the channel management unit may be configured to: when the backup channel in the rendezvous combination is assigned to the operating channel, choose one candidate channel from the candidate channel set, and assign the selected candidate channel to a backup channel in the rendezvous combination to produce a new rendezvous combination.

Further, the channel management unit may be configured to select the one candidate channel on a basis of a characteristics of the respective candidate channels in the candidate channel set and a requirement of an RF channel.

Further, the apparatus may further comprise a channel information acquisition unit configured to acquire information about available channels and unavailable channels in the radio system that support the multiple channels; a channel sensing unit configured to perform a spectrum sensing on the acquired channel information to provide a result of the spectrum sensing to the channel management unit; and a channel information exchange unit configured to receive a channel list managed by an external communication device by performing a communication with an external communication device, wherein the channel management unit is configured to constitute the channel sets based on the result of the spectrum sensing and the received channel list.

Further, the apparatus may further comprise a channel sensing unit configured to, when the operating channel in the rendezvous combination is not suitable for the communications, put the unsuitable operating channel in the unclassified channel set to check the possible use some time later, perform a spectrum sensing on the respective channels in the unclassified channel set and update the candidate channel set using the result of the spectrum sensing.

Further, the apparatus may further comprise a management unit of spectrum sensing period configured to set a sensing period for the operating channel set, the backup channel set and the candidate channel set, and a sensing period for the unclassified channel set, respectively.

In accordance with an embodiment of the present invention, a back channel is correctly assigned to a new operating channel through a rendezvous combination when an operating channel is not suitable for the communications; therefore, communication obstacles may be stably overcome in a short time.

### BRIEF DESCRIPTION OF THE DRAWINGS

The above and other objects and features of the present invention will become apparent from the following description of the embodiments given in conjunction with the accompanying drawings, in which:

FIG. 1 is a diagram of a variety of channels that are managed by a DSA radio system in accordance with an embodiment of the present invention;

FIG. 2 is a flow diagram illustrating a process of managing channels in a DSA radio system in accordance with an embodiment of the present invention;

FIGS. 3A and 3B illustrate an example of rendezvous combinations in accordance with an embodiment of the present invention; and

FIG. 4 is a block diagram of an apparatus for managing channels in a DSA radio system in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, a method and apparatus for managing radio channels in a DSA (Dynamic Spectrum Allocation) radio system that supports multiple channels in accordance with an embodiment of the present invention will be described in detail with reference to the accompanying drawings.

The DSA radio system of the embodiment searches a spectrum of existing systems (or primary users), finds out white channels, which is not used in region or in time and communicates through the white channels in order not to make interference with the primary users. Since a primary user can access a permitted spectrum to transmit signals any time, the DSA radio system of the embodiment performs a spectrum sensing periodically even while using a particular frequency (or channel). If the primary user is appeared, the DSA radio communication system shall not use the channel accessed by the primary user within the stipulated time. A frequency band is divided into a number of channels for the use of it; thus, it is assumed in the embodiment that a channel is a basic unit for assigning a frequency band to either the primary user or the DSA radio system.

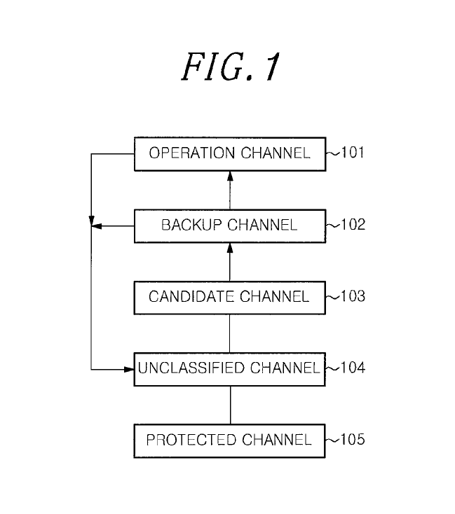

The DSA radio system is able to use multiple RF transceivers and manages multiple channels by classifying the channels. Channels used in the DSA radio system will be described with reference to FIG. 1 as below.

FIG. 1 is a diagram of a variety of channels that are managed by the DSA radio system in accordance with an embodiment of the present invention. The channels include an operating channel 101, a backup channel 102, a candidate channel 103, an unclassified channel 104 and a protected channel 105.

These channels are classified according to the result of a spectrum sensing and information exchanged among the neighboring communication parties.

The operating channel 101 refers to a channel at which the DSA radio system is currently using, and the backup channel 102 refers to a channel to be used when a switching of an operating channel is required due to the appearance of a primary user or the generation of a jamming. Further, the candidate channel 103 refers to a channel that is used to extract a backup channel 102 when a backup channel is assigned to an operating channel, and the protected channel 105 means a channel that shall not be available by the DSA radio system.

Finally, the unclassified channel 104 refers to, among the available channels, a remainder channel that is not a member of the operating (101), backup (102), and candidate channels (103).

Spectrum sensing module in the DSA radio system measures the available channels except for the protected channel 105, that is, the operating, backup, candidate channel and unclassified channels 101, 102, 103 and 104, and produces rendezvous combinations of an operating channel-backup channel pair by pairing the operating channel and the backup channel in an 1:1 relation, and manages the channels based on the rendezvous combinations.

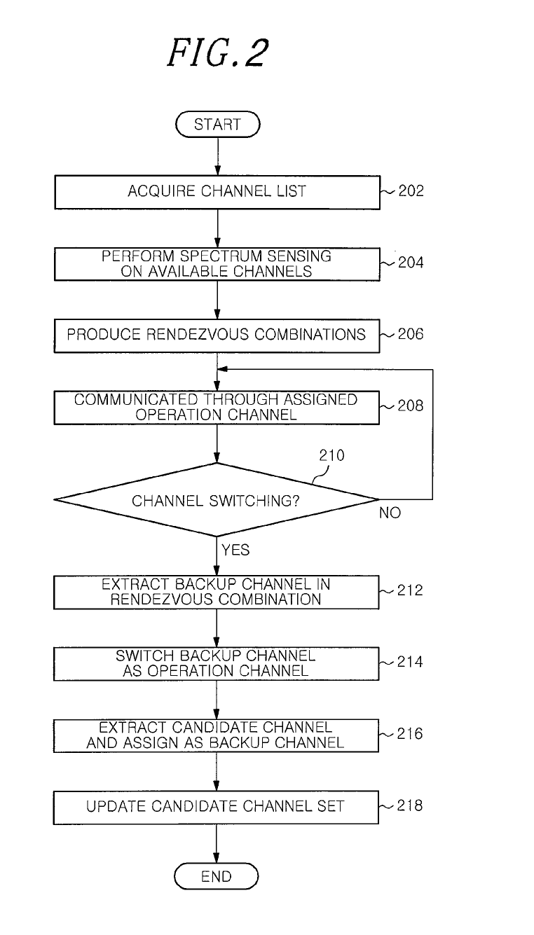

The management of the channels will now be described with reference to FIG. 2 as follows.

FIG. 2 is a flow diagram illustrating a process of managing channels in a DSA radio system in accordance with an embodiment of the present invention.

Referring to FIG. 2, the DSA radio system inquires an available channel list (i.e., a list of channels that are available) and an unavailable channel list (i.e., a list of channels that are not available) to a database system that manages the frequency resources to acquire a channel list, in an operation 202. In this case, the database serves to store the available channel list and the unavailable channel list depending on a geolocation and provides these lists to a DSA system if specifically requested. In this embodiment, an unavailable (or protected) channel refers to a channel that is not permitted to use on a permanent basis.

After that, a spectrum sensing is performed on the available channels to classify the available channels into a set of operating channels, a set of backup channels, a set of candidate channels, and a set of unclassified channels in accordance with the state of the channels, in an operation 204.

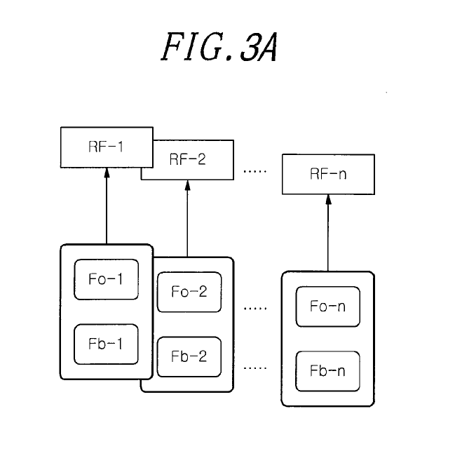

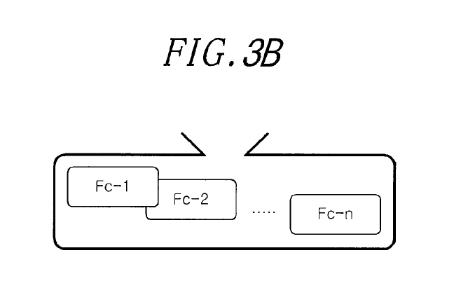

Next, the DSA radio system pairs the operating channels in the operation channel set and the backup channels in the backup channel set in an 1:1 relation in the available channel list, thereby producing a plurality of rendezvous combinations, in an operation 206. That is, as shown in FIG. 3A, the rendezvous combinations, which are composed of RF-1, RF-2, . . . , RF-n, are derived from an operating channel set, which is composed of Fo-1, Fo-2, . . . , Fo-n, and a backup channel set, which is composed of a Fb-1, Fb-2, . . . , Fb-n. Further, as shown in FIG. 3B, the DSA radio system is able to manage a candidate channel set, which is composed of Fc-1, Fc-2, . . . , Fc-n.

Thereafter, when a communication is performed through any operating channel, for example, an operating channel Fo-1 is in a rendezvous combination with Fb-1 of RF-1 in an operation 206, it is determined whether a channel switching is necessary, in an operation 210. An operation related to the channel switching refers to an action to suspend an operating channel in use in the DSA radio system, which becomes unusable, and move to backup channel. As a result of the determination of the operation 210, when it is determined that the channel switching is necessary, the DSA radio system chooses any rendezvous combination that is determined in a spectrum sensing operation 204, for example, a rendezvous combination RF-1, and extracts a backup channel Fb-1 which is included in the rendezvous combination RF-1, in an operation 212.

Meanwhile, as a result of the determination in the operation 210, if it is no need to perform the channel switching, the RF transceiver continuously communicates through the operating channel which has been previously assigned in the operation 206.

After the operation 212, the DSA radio system assigns the backup channel to the operating channel from the rendezvous combination and continues to communicate through the new operating channel, in an operation 214. Thus, the backup channel Fb-1 is substituted for the operating channel Fo-1 in the rendezvous combination RF-1, and the previous operating channel in the rendezvous combination RF-i (where i=1, . . . , n), which is eliminated from the operating channel is classified into unclassified channels. Further, because the backup channel is substituted for the operating channel, the backup channel in the rendezvous combination becomes empty.

Next, the DSA radio system extracts one candidate channel from the candidate channel set and assigns it to the backup channel in the rendezvous combinations RF-i, in an operation 216. In this case, in order to find out a new backup channel, the method of extracting the candidate channel from the candidate channel set may be determined depending on both characteristics of the respective candidate channels and the requirements of the corresponding RF channel. That is, the candidate channel meeting the requirements of RF-i may be assigned to the backup channel in the rendezvous combinations RF-i.

Thereafter, the DSA radio system selects one candidate channel in the candidate channel set in an operation 216. In this case, the candidate channel set may be updated by shifting the priority of the respective candidate channels in the candidate channel set by one step.

Meanwhile, the DSA radio system performs the spectrum sensing for every operating channel set, backup channel set, candidate channel set and the unclassified channel set to update the respective channel sets with different sensing period, respectively.

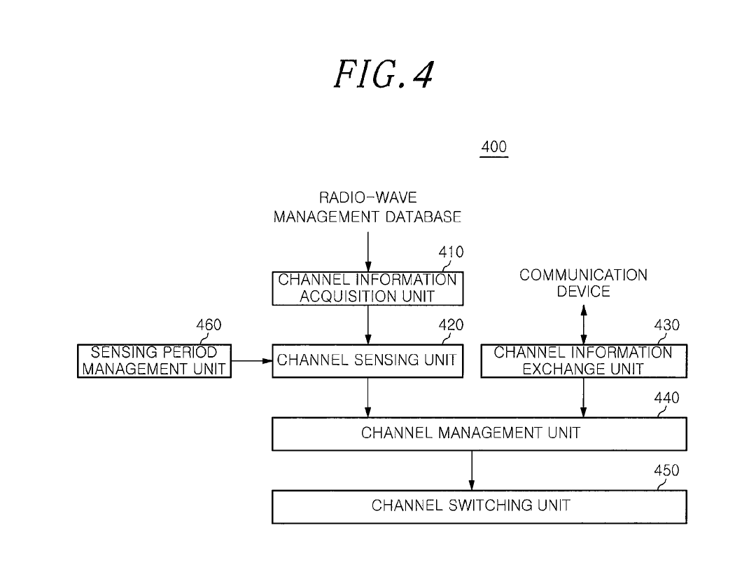

FIG. 4 illustrates an apparatus for managing channels in a DSA radio system that supports multiple channels in accordance with an embodiment of the present invention. The apparatus for managing channels may be incorporated in the DSA radio system.

Referring to FIG. 4, the apparatus 400 for managing channels of the DSA radio system includes a channel information acquisition unit 410, a channel sensing unit 420, a channel information exchange unit 430, a channel management unit 440, a channel switching unit 450, a sensing period management unit 460.

The channel information acquisition unit 410 of FIG. 4 queries a radio-wave database system an information on a list of available channels, i.e., a list of channels that are available and an unavailable channel list, i.e., a list of channels that are not available in an area where the DSA radio system is located and offers the acquired information to the channel sensing unit 420. Here, the channel sensing unit performs spectrum sensing on the available channels and makes channel sets temporarily, i.e., the operating channel set, the backup channel set, the candidate channel set and the unclassified channel set. On the other hand, channel information exchange unit 430 exchanges channel information with neighboring communication parties and channel management unit 440 makes final decision of channel sets from both local channel sets made by the DSA radio system itself and the channel information from the neighboring parties.

The channel sensing unit 420 continues to perform the spectrum sensing on the available channels periodically to determine which channels are available in the area or occupied by the primary user or another DSA system. The result of the spectrum sensing is then provided to the channel management unit 440. A channel sensing period performed on the operating channels, the backup channels and the candidate channels is set in a short sensing cycle so that it does not interfere with the primary user, while the channel sensing period performed on the unclassified channels is set in a long sensing period so that it senses them when the DSA radio system is not busy or the candidate channel is empty.

On the other hand, the primary user mentioned in the embodiment of the present invention is a system that utilizes a frequency band that is permitted, for an example, it may be TV broadcast systems, but not limited thereto.

The channel information exchange unit 430 is intended for the exchange of information about the channel sets periodically in order to maintain the same channel sets for management with communicating partners (i.e., other communication devices). The channel information exchange unit 430 provides the channel sets for management to the communication partner or receives the channel sets for management from the communicating partners. The information about the channel sets is provided to the channel management unit 440.

The channel management unit 440 constitutes and manages the operating channel set to select an operating channel based on the result of the spectrum sensing and the information about the channel sets for other communication devices that were sent from the channel information exchange unit 430, the backup channel set that has an 1:1 relation to the operating channel and will be switched to a backup channel if the channel switching is required.

In addition, the channel management unit 440 may choose the operating channel set and the backup channel set to meet the requirements of the respective RF channels based on the spectrum sensing in terms of operating frequency, channel bandwidths, and noise floor et cetra.

The channel management unit 440 produces a number of rendezvous combinations by pairing the operating channel set and the backup channel set in an 1:1 relation through the use of both locally measured channel sets and externally communicated channel sets through the channel information exchange unit 430.

An unclassified channel set refers to channels that does not belong to the operating channel, the backup channel and the candidate channels among the available channels.

In a situation that the DSA radio system performs communication using any arbitrary operating channel in the rendezvous combination, when it is determined that the operating channel is not suitable for communications, i.e., when it is required to switch the operating channel due to a jamming or an appearance of a primary user, the channel switching unit 450 performs the channel switching to the backup channel in combination with pairing with the operating channel in the rendezvous combination and then continues to communicate through the switched backup channel, i.e., new operating channel.

When the backup channel is switched as the operating channel, the channel management unit 440 chooses an appropriate candidate channel from the candidate channel set and assigns it as the backup channel in the rendezvous combination, thereby producing a new rendezvous combination.

Meanwhile, when any operating channel is not suitable for communications, the channel sensing unit 420 puts the current operating channel in the unclassified channel set so that the channel sensing unit 420 can perform spectrum sensing according to the channel sensing period set by the sensing period management unit 460.

The sensing period management unit 460 sets the channel sensing period of the operating channels, the backup channels and the candidate channels, and the channel sensing period of both the operating channels and the backup channels can be relatively shorter than that of candidate channels in order not to interfere with the primary user. And the sensing period of the unclassified channels may be longer than that of candidate channels, so that the channel sensing can be made when there is enough time. The sensing period that is set in this manner is then provided to the channel sensing unit 420.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for dynamically managing channels in a radio system that supports multiple channels, the method comprising:
producing a number of rendezvous combinations by pairing operating channels and backup channels in an 1:1 relation based on an available channel list;
when an arbitrary operating channel in a rendezvous combination is not suitable for communications, extracting a backup channel from the rendezvous combination to which the arbitrary operating channel belongs; and
switching the extracted backup channel as an operating channel to continue a communication.

2. The method of claim 1, wherein the available channel list is composed of an operating channel set, a backup channel set, a candidate channel set, and unclassified channel set.

3. The method of claim 2, further comprising:
after switching the extracted backup channel to the operating channel, extracting an appropriate channel from the candidate channel set and assigning the channel to the backup channel; and
producing a new rendezvous combination using the updated operating channel and the updated backup channel.

4. The method of claim 3, wherein said extracting the candidate channel comprises:
extracting a candidate channel which meet the requirements of RF channel among the candidate channels in the candidate channel set.

5. The method of claim 4, further comprising:
after switching the extracted backup channel as an operating channel, assigning a new backup channel from the candidate channel which meet the requirements of RF channel among the candidate channels in the candidate channel set, and updating the candidate channel set by changing the priority of the respective channels in the candidate channel set.

6. The method of claim 2, further comprising:
putting the operating channel, which was eliminated from the operating channel, in the unclassified channel set to update the unclassified channel set and performing a channel sensing on the channels in the updated unclassified channel set and updating the candidate channel set on the basis of the channel sensing.

7. An apparatus for dynamically managing channels in a radio system that supports multiple channels, the apparatus comprising:
a channel management unit configured to pair operating channels and backup channels in an 1:1 relation to produce a number of rendezvous combinations based on an available channel list assigned to the radio system; and
a channel switching unit configured to, when any arbitrary operating channel is not available in a rendezvous combination, extract a backup channel from the rendezvous combination to which the any operating channel belongs and switch the extracted backup channel to an operating channel.

8. The apparatus of claim 7, wherein the channel management unit is configured to classify the channels in available channel list into an operating channel set, a backup channel set, a candidate channel set, and unclassified channel set for the management thereof.

9. The apparatus of claim 8, the channel management unit is configured to:
when the backup channel in the rendezvous combination is switched to the operating channel, choose one candidate channel from the candidate channel set, and assign the selected candidate channel to a backup channel in the rendezvous combination to produce a new rendezvous combination.

10. The apparatus of claim 9, wherein the channel management unit is configured to select one candidate channel on a basis of a priority of the respective candidate channels in the candidate channel set and a requirement of an RF channel.

11. The apparatus of claim 7, further comprising:
a channel information acquisition unit configured to acquire information about available channels and unavailable channels in the radio system that support the multiple channels;
a channel sensing unit configured to perform a spectrum sensing on the acquired channel information to provide a result of the spectrum sensing to the channel management unit; and
a channel information exchange unit configured to receive a channel list managed by an external communication device by performing a communication with an external communication device,
wherein the channel management unit is configured to constitute the channel sets based on the result of the spectrum sensing and the received channel list.

12. The apparatus of claim 8, further comprising:
a channel sensing unit configured to, when the operating channel in the rendezvous combination is not suitable for communications, put the current operating channel, which is being eliminated from the operating channel set, in the unclassified channel set to update the unclassified channel set, perform a spectrum sensing on the respective channels in the unclassified channel set and update the candidate channel set using the result of the sensing.

13. The apparatus of claim 8, further comprising:
a sensing period management unit configured to set a sensing period for the operating channel set, the backup channel set and the candidate channel set, and a sensing period for the unclassified channel set.
